(19) United States
(12) Patent Application Publication
(10) Pub. No.: US 2007/0114812 A1
(43) Pub. Date: May 24, 2007

(54) Insulation Panel

(76) Inventor: Christopher H. Hunt, Sterling Heights, MI (US)

Correspondence Address: GREGORY T. ZALECKI, 12900 HALL ROAD, SUITE 400, STERLING HEIGHTS, MI, 48313, US

(21) Appl. No.: 11/456,736

(22) Filed: Jul. 11, 2006

(51) Int. Cl. B62D 25/00

(52) U.S. Cl. 296/181.6; 296/191

(57) ABSTRACT

An insulation panel for thermally insulating the passenger compartment of a vehicle is comprised of a section of insulation, a layer of pressure sensitive adhesive, a layer of release material and a protective cover. The insulation is medium density polyethylene cross-linked closed cell foam formulated with a fire retardant additive. The adhesive is preferably thermally stable to 250° F. The adhesive is applied to the bottom of the insulation and covered by the release material to create a peel and stick surface. The protective cover is thermoplastic polyolefin or polyurea bonded to the top of the insulation. The insulation panel is shaped to fit an exterior or interior passenger compartment surface. The insulation panel is color matched to the intended environment of vehicle use.

### BACKGROUND

Vehicles are often designed and manufactured for use within one environment and then used in another environment. The other environment may expose the vehicle to unanticipated extreme continuous temperatures. For example, many military vehicles and construction vehicles were designed for use within environments similar to those found within the continental United States and are then being used in desert and high temperature areas of the Middle East.

The internal cabin temperatures of those vehicles often border on the unbearable. Rooftop vehicle temperatures can reach 250° F. The headliner surface areas within the cabin can also reach 250° F. These temperatures are caused by solar radiation. Even when the vehicles are equipped with an air-conditioning system it is difficult to keep cabin temperatures below 85° F. The interior roof and door temperatures can become too hot to touch.

Some vehicles are retrofitted with armor. The doors, roof and side panels of the vehicle may be armored. The armor is typically a high strength metal. The armor acts as a heatsink. As a result, the excessive cabin temperature problem is aggravated further. To make matters worse the extra weight added to the vehicle by the armor requires additional engine power to move the vehicle. The additional engine power required to move the vehicle results in less engine power being available to power the air-conditioning system.

Many of the interior cabin surfaces on military and construction vehicles are unpadded metal. The unpadded metal often becomes too hot to touch in extreme environments. The unpadded metal can also cause injuries when it is contacted by the vehicle occupants during periods of vehicle turbulence.

It is desirable, and an object of this invention, to be able to retrofit (and initially manufacture) vehicles with interior and exterior cabin thermal insulation. The insulation will be placed upon the vehicle roof and also upon the interior cabin surfaces such as the doors of a vehicle and the interior roof surface. This cabin insulation will allow a vehicle air-conditioning system to provide enhanced cooling within the cabin, resulting in a lower passenger compartment temperature.

A new and improved insulation panel is needed. The insulation panel would have the following properties. It would be lightweight. It would be flame retardant and ultraviolet resistant. It would be easy to shape and to install. It should have an adhesive coating covered by a release material which would allow peel and stick application to a vehicle. It should facilitate retrofitting the cabin and roof of an existing vehicle. It should provide padded interior cabin surfaces. It should be aesthetically pleasing and facilitate color matching with the environment to assist in camouflaging the vehicle. It should be abrasion resistant and puncture resistant. It should be moisture resistant. It should be stable when continuously exposed to temperatures of up to 250° F. It should be stable and durable, whether applied to an interior cabin surface or an exterior cabin surface.

### SUMMARY

The insulation panel described herein provides these features and benefits. The insulation panel is intended to be used to insulate the passenger compartment of a vehicle. The passenger compartment is comprised of exterior passenger compartment surfaces and interior passenger compartment surfaces.

In its simplest form the insulation panel is comprised of a section of insulation and a protective cover. The section of insulation is closed cell foam insulation. It has a top surface and a bottom surface. Preferably, the insulation is comprised of closed cell polyolefin foam. The best insulation is medium density polyethylene cross-linked closed cell foam. The foam should be cross-linked by irradiation, rather than chemically. The foam is formulated with a fire retardant additive to limit its flammability. Preferably, it is also formulated with an ultraviolet radiation resistant additive.

Medium density polyethylene cross-linked by irradiation closed cell foam is typically extruded into relatively thin plies during the manufacturing process. The desired foam thickness is obtained by laminating the plies together. The bottom surface of the section of insulation should be comprised of a layer of ethylene vinyl acetate (EVA) foam. EVA provides a better base for the application of release material covered adhesive. The release material is more likely to separate from the adhesive, rather than cause the adhesive to pull away from the insulation, when the release material is removed.

The protective cover is bonded to the top of the foam insulation. The protective cover is comprised primarily of thermoplastic polyolefin or polyurea. Preferably, the protective cover is formulated with a fire retardant additive and an ultraviolet radiation resistant additive.

The protective cover and the insulation should be color matched to the intended environment of vehicle use. For example, if the vehicle is intended to be used within a sandy desert environment, the protective cover and the insulation should be sand colored.

Additionally, a layer of adhesive and a layer of release material should be applied to the bottom of the insulation. The adhesive must be thermally stable within the environmental temperature range of expected use. It should be thermally stable at 200° F. and is preferably thermally stable at 250° F. The preferred adhesive is a pressure sensitive acrylic adhesive.

The release material releasably covers the adhesive. It provides a nonstick surface at the bottom of the foam insulation. It may be pulled away from the adhesive to expose the adhesive.

In order to retrofit a vehicle with an insulation panel the insulation panel must be shaped to fit a passenger compartment surface of the vehicle. If the insulation panel is to be used upon the exterior roof surface of a vehicle, one or more panels should be cut to fit the roof surface. If the insulation panel is to be used upon an interior door surface, it should be cut to fit that door surface. Typically, this would involve shaping the perimeter of the insulation panel to fit the perimeter of the interior surface of the door and cutting out any necessary openings, such as a window opening.

Shaped insulation panels may be provided to a user as a kit of panels. Each panel is shaped to fit an exterior or interior passenger compartment surface. The panels provided would cover the roof and the interior passenger compartment surfaces.

### DRAWINGS

These and other features, aspects, and advantages of the present invention will become better understood with regard to the following description, appended claims, and accompanying drawings where:

FIG. 1 is a perspective view of a vehicle with a roof covered by an insulation panel.

FIG. 2 is a perspective view of an insulation panel having a thermoplastic polyolefin cover.

FIG. 3 is a cross-sectional elevation view of the insulation panel having a thermoplastic polyolefin cover of FIG. 2.

FIG. 4 is a perspective view of the interior of the vehicle of FIG. 1 showing interior passenger compartment surfaces covered by insulation panels.

FIG. 5 is a perspective view of an insulation panel having a polyurea cover.

FIG. 6 is a cross-sectional elevation view of the insulation panel having a polyurea cover of FIG. 5.

FIG. 7 is a perspective view of a vehicle having a differently configured roof, wherein the roof is covered by four insulation panels.

FIG. 8 is a perspective view of a kit of insulation panels shaped to fit the exterior passenger compartment surface and the interior passenger compartment surfaces of the vehicle of FIG. 7.

### DESCRIPTION

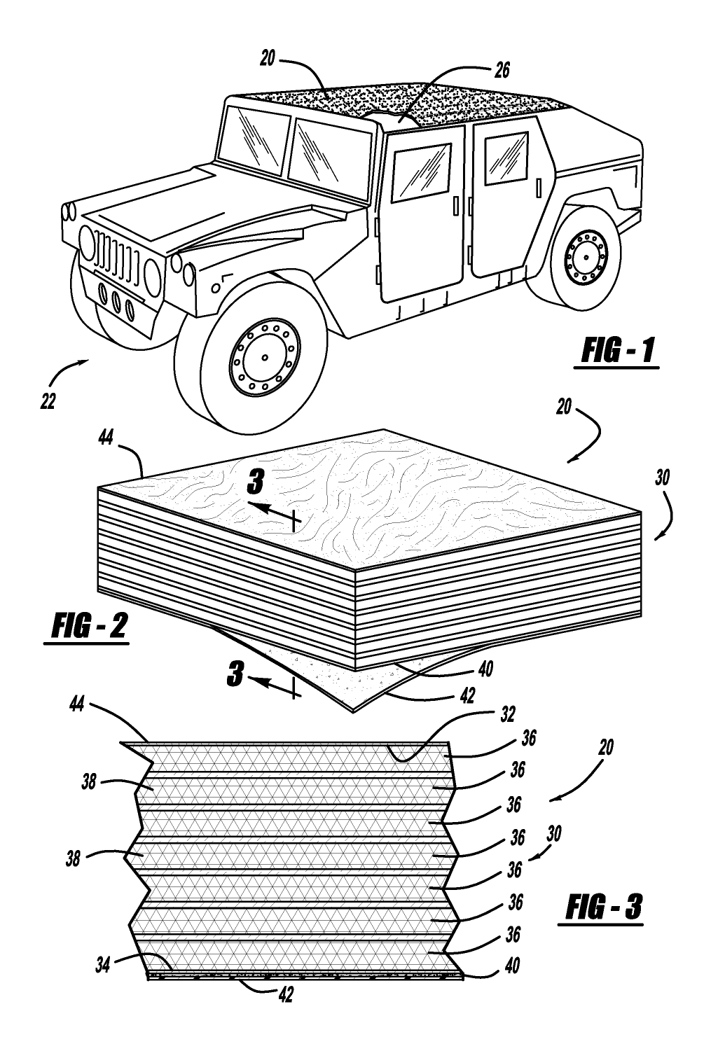

The preferred embodiment of an insulation panel 20 is comprised of a section of insulation 30, a layer of adhesive 40, a layer of release material 42 and a protective cover 44. The insulation panels 20 described herein are useful for insulating the passenger compartment 24 of a vehicle 22. The vehicle 22 may be a military vehicle, such as a Humvee, or a construction vehicle. The vehicle 22 is likely to be used within a hot environment. Therefore, it will be desirable to insulate the passenger compartment 24 of the vehicle 22 in order to enhance the cooling capacity of the vehicle's 22 air-conditioning system. The passenger compartment 24 is made up of exterior passenger compartment surfaces 26 and interior passenger compartment surfaces 28. Typical exterior passenger compartment surfaces 26 and interior passenger compartment surfaces 28 are illustrated in FIG. 1 and FIG. 4. The exterior roof of the vehicle 22 is an exterior passenger compartment surface 26. The interior door surface areas, the interior roof/headliner area and other vehicle body structural surfaces are interior passenger compartment surfaces 28 and surround the passenger compartment 24. One of the objects of this invention is to provide an insulation panel 20 which is useful for insulating the exterior passenger compartment surfaces 26 and the interior passenger compartment surfaces 28 of a vehicle 22. A vehicle 22 so insulated will have a lower passenger compartment 24 temperature than an uninsulated vehicle when the vehicle 22 is air-conditioned by a vehicle air-conditioning system while the vehicle is within a hot environment, such as a desert in the Middle East during the summer season.

The section of insulation 30 is comprised of closed cell foam. The section of insulation 30 has a top surface 32 and a bottom surface 34. Preferably, the section of insulation 30 is comprised of medium density polyethylene closed cell foam which has been cross-linked by irradiation. This material has a density of approximately 2 pounds per cubic foot. It is comprised of many small cells 38. It should be manufactured with a foaming agent which produces nitrogen encapsulated cells. This will avoid the emission of toxic or noxious fumes when the cells within the foam outgas. The closed cells of the foam provide rigidity and resist the absorption of water and other contaminants.

Cross-linking is the joining of polymers by the creation of covalent bonds. Cross-linking by irradiation involves directing an electron beam or electromagnetic radiation at the foam, or the raw materials used to produce the foam, during the manufacturing process. Cross-linking by irradiation produces superior cell properties compared to cross-linking chemically. The cells are stiffer and more thermally stable (i.e. withstand a higher temperature). The foam also tends to be self extinguishing.

In the preferred embodiment the foam is formulated with a fire retardant additive and an ultraviolet radiation resistant additive. These properties can be obtained by brominating the resin used to manufacture the foam, or brominating the foam while it is being extruded during the manufacturing process. Other halogens may also be used. Other fire retardant additives and ultraviolet radiation resistant additives, and processes for enhancing the fire retardant and ultraviolet radiation resistant properties of foam, both proprietary and nonproprietary, known to those skilled in the art of foam fabrication, are within the scope of this invention. An irradiation cross-linked polyethylene foam with a continuous smooth surface, fine cell structure, and improved fire retardant properties is currently being sold under the trade name “VOLARA TYPE MF” by Voltek, LLC. “VOLARA TYPE MF” exceeds the United States federal Motor Vehicle Safety Standard 302 horizontal flame retardant test.

Irradiation cross-linked polyethylene foam is typically extruded into relatively thin sheets or plies 36 at the time of manufacture. Larger thicknesses can be obtained by laminating the plies 36 together. The plies 36 are heated to the point of being tacky and then compressed to form a laminated bond. Optimal foam thickness for use within the passenger compartment 24 of a vehicle 22 has been found to be approximately 1 inch. The optimal foam thickness for use on the exterior passenger compartment surfaces 26 has been found to be approximately 0.44 inches. However, the scope of this invention is not limited by the foam thickness of an insulation panel 20.

A layer of adhesive 40 is applied to the bottom of the section of insulation 30. The adhesive 40 must be thermally stable at temperatures up to 200° F. Preferably, the adhesive 40 is thermally stable up to a temperature of approximately 250° F. The adhesive 40 should be a pressure sensitive acrylic adhesive. This will allow an insulation panel 20 to be pressed onto an interior roof surface of a vehicle and immediately bonded such that it will not fall. Acrylic adhesives 40 are known to be thermally stable at temperatures up to 250° F. Acrylic adhesives 40 can also be pressure sensitive such that a bond is formed when two parts are compressed around the adhesive.

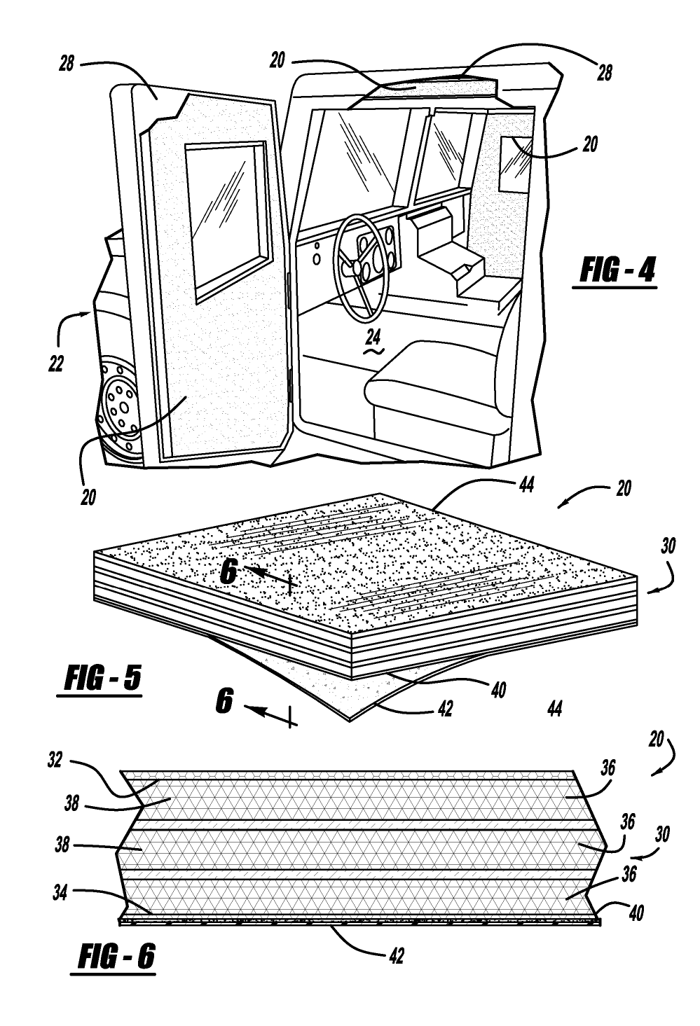

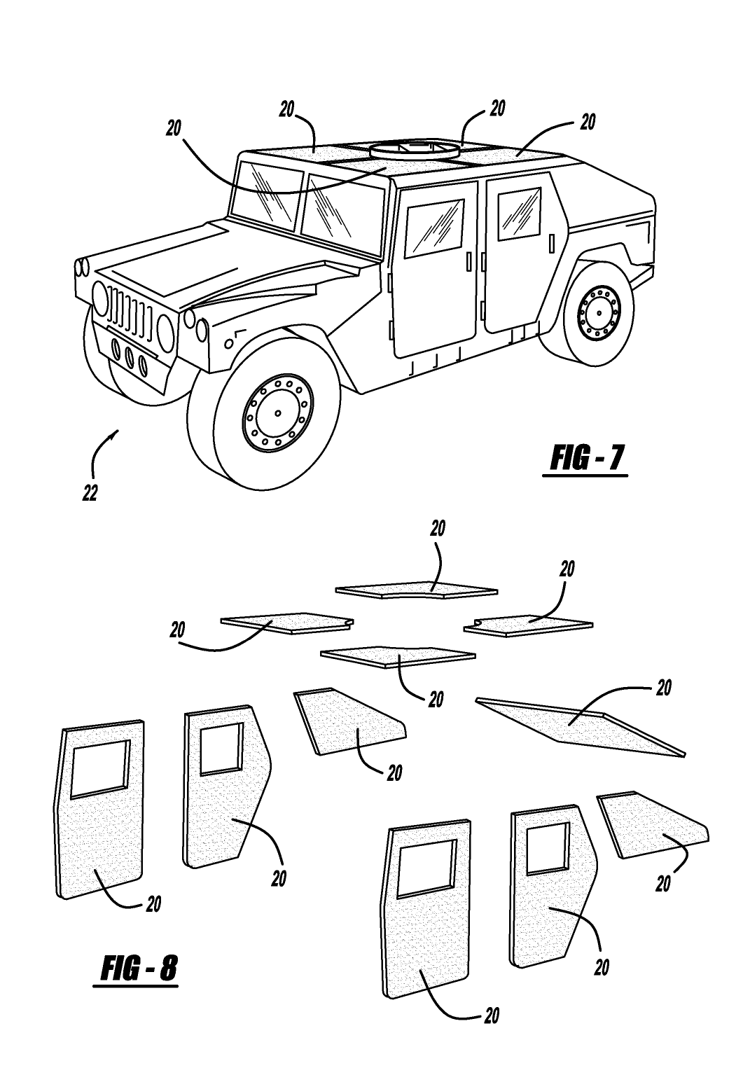

A layer of release material 42 covers the adhesive 40. The release material 42 is adapted to releasably cover the adhesive 40 such that a nonstick surface is formed at the bottom of the foam insulation 30. Because the release material 42 is adapted to releasably cover the adhesive 40 the insulation panel 20 is provided with a peel and stick feature, as shown in FIG. 2 and FIG. 5. The insulation panel 20 can be stored without fear that it will bond to another material because the adhesive 40 is covered by the release material 42. The release material 42 may be kraft paper. When it is desired to apply the insulation panel 20 to a vehicle 22 the release material 42 is pulled away from the adhesive 40.

An adhesive 40 satisfying the criteria set forth is currently being sold by 3M as “ADHESIVE TRANSFER TAPE 6035PC” and “ADHESIVE TRANSFER TAPE 6035PL.” These are pressure sensitive adhesive transfer tapes. The adhesive 40 and the release material 42 are combined into a tape and sold in rolls. This adhesive tape can be applied to the section of insulation 30 by sending the section of insulation 30 and the tape through a pinch roller while the adhesive 40 of the tape is in contact with the bottom of the section of insulation 30.

It has been discovered that, at times, the adhesive 40 may be pulled away from the section of insulation 30 when it is desired to only pull away the release material 42 from the adhesive 40 and leave the adhesive adhered to the section of insulation 30. This problem may be solved by providing the section of insulation 30 with a bottom surface comprised of a 1/16″ layer or ply 36 of ethylene vinyl acetate (EVA) foam. This is accomplished by laminating a layer or ply 36 of ethylene vinyl acetate (EVA) foam to the bottom of the section of insulation 30. The adhesive 40 does not pull away from the ethylene vinyl acetate (EVA) foam when the release material 42 is pulled away from the adhesive 40. Ethylene vinyl acetate (EVA) foam suitable for this use is currently being sold under the trade name “VOLARA TYPE EO” by Voltek, LLC.

The protective cover 44 is bonded to the top of the section of foam insulation 30. This invention encompasses two types of protective covers 44. The first is primarily thermoplastic polyolefin. The second is primarily polyurea. When the insulation panel 20 is used to cover an exterior passenger compartment surface 26, such as an exterior roof surface, a 0.44 inch (approximate) thick section of insulation foam 30 should be used with a polyurea protective cover 44. When the insulation panel 20 is used to cover an interior passenger compartment surface 28, such as an interior door panel, a 1 inch thick (approximate) section of insulation foam 30 should be used with a thermoplastic polyolefin protective cover 44. This invention is not limited to these two foam thicknesses.

Preferably, both the thermoplastic polyolefin protective cover 44 and the polyurea protective cover 44 have been formulated with a fire retardant additive and an ultraviolet radiation resistant additive. Fire retardant and UV resistant properties can be obtained by brominating the protective cover 44 during the manufacturing process. Other halogens may also be used. Other fire retardant additives and ultraviolet radiation resistant additives, and processes for enhancing the fire retardant and ultraviolet radiation resistant properties of thermoplastic polyolefin and polyurea, both proprietary and nonproprietary, known to those skilled in the art of thermoplastic polyolefin coating and polyurea coating fabrication, are within the scope of this invention.

The thermoplastic polyolefin protective cover 44 should preferably be between 0.003 inches and 0.050 inches thick. It is typically extruded during the manufacturing process. The extruded thermoplastic polyolefin protective cover 44 is heat fused to the top ply 36 or top surface 32 of the section of insulation 30. The thermoplastic polyolefin protective cover 44 should be of the soft polypropylene type. By covering the section of insulation 30 with a thermoplastic polyolefin protective cover 44, the insulation panel is made more durable, more abrasion resistant, more puncture resistant, more aesthetically pleasing and better insulating. A leather grain texture may also be embossed upon the thermoplastic polyolefin protective cover 44 to make the protective cover more aesthetically pleasing and comfortable to touch.

The polyurea protective cover 44 is sprayed onto the top of the section of insulation 30. It encapsulates the foam 30 and provides a durable hard finish which is ultraviolet radiation resistant. The polyurea protective cover 44 provides excellent chip, scratch and impact resistance. It provides enhanced blast mitigation. It is self extinguishing. It does not give off volatile vapors. It provides excellent adhesion for CARC (Chemical Agent Resistant Coating) paint used on military vehicles. It is easy to repair. A polyurea coating sold by PPG under the trade name “MIL-TOUGH” currently provides the most preferred properties for a polyurea protective cover 44 for the section of insulation 30.

In the preferred embodiment the protective cover and the section of foam 30 are color matched to the intended environment of vehicle 22 use. For example, if the vehicle 22 is intended to be used within a sandy desert environment, the protective cover 44 and the section of insulation 30 should be sand colored.

In order to use one or more insulation panels 20 to insulate a vehicle 22, each insulation panel 20 is shaped to fit a passenger compartment 24 surface of the vehicle 22. For example, insulation panels 20 to be used to cover a vehicle 22 roof are shaped to conform to the roof shape, as shown in FIG. 7 and FIG. 8. Similarly, insulation panels 20 to be used to cover an interior door surface 28, or other interior passenger compartment surface 28, are shaped to conform to those surfaces, as also shown in FIG. 7 and FIG. 8. The insulation panels 20 may be provided in a kit form. Each insulation panel 20 of the kit is shaped to fit a separate passenger compartment 24 surface of the vehicle 22, as shown in FIG. 8. In order to secure a properly shaped insulation panel 20 to the vehicle 22, the release material 42 is peeled away from the adhesive 40 on the section of insulation 30. The insulation panel 20 is then pressed into place resulting in an insulated vehicle 22, as shown in FIG. 1, FIG. 4 and FIG. 7. The insulated vehicle 22 will have a much reduced passenger compartment 24 temperature when the vehicle 22 air-conditioning system operates within a hot environment.

Although the invention has been shown and described with reference to certain preferred embodiments, those skilled in the art undoubtedly will find alternative embodiments obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An insulation panel for insulating the passenger compartment of a vehicle having one or more exterior passenger compartment surfaces and one or more interior passenger compartment surfaces, said insulation panel comprising:
(a) a section of closed cell foam insulation having a top surface and a bottom surface, said foam insulation being further formulated with a fire retardant additive; and
(b) a protective cover bonded to the top of the foam insulation, said protective cover being comprised primarily of thermoplastic polyolefin or polyurea.

2. The insulation panel of claim 1, wherein the foam insulation is comprised of foam insulation plies laminated together, and wherein the closed cell foam insulation is cross-linked by irradiation.

3. The insulation panel of claim 1, further comprising
(a) a layer of adhesive applied to the bottom of the section of insulation, said adhesive being thermally stable as an adhesive up to a temperature of approximately 200° F.;
(b) a layer of release material covering the adhesive, said release material being adapted to releasably cover the adhesive such that a nonstick surface is formed at the bottom of the foam insulation; and wherein
(c) the foam insulation is comprised of medium density polyethylene cross-linked closed cell foam.

4. The insulation panel of claim 1, wherein the closed cells of the foam insulation initially encapsulate essentially nitrogen, wherein the foam insulation is formulated with an ultraviolet radiation resistant additive, and wherein the protective cover is formulated with a fire retardant additive and an ultraviolet radiation resistant additive.

5. The insulation panel of claim 1, wherein the insulation panel is shaped to fit a passenger compartment surface of the vehicle.

6. The insulation panel of claim 1, wherein the insulation panel is attached to a passenger compartment surface by an the adhesive.

7. A kit of insulation panels as defined in claim 1, wherein each said insulation panel is shaped to fit a separate passenger compartment surface of the vehicle.

8. The insulation panel of claim 1, wherein the protective cover is color matched to an intended environment of vehicle use.

9. The insulation panel of claim 1, wherein the protective cover is primarily comprised of thermoplastic polyolefin.

10. The insulation panel of claim 1, wherein the protective cover is primarily comprised of polyurea.

11. An insulation panel for insulating the passenger compartment of a vehicle having one or more exterior passenger compartment surfaces and one or more interior passenger compartment surfaces, said insulation panel comprising:
(a) a section of insulation comprised of closed cell polyolefin foam, said section of insulation having a top surface and a bottom surface;
(b) a layer of pressure sensitive adhesive applied to the bottom of the section of insulation, said adhesive being thermally stable as an adhesive up to a temperature of approximately 200° F.;
(c) a layer of release material covering the adhesive, said release material being adapted to releasably cover the adhesive such that a nonstick surface is formed at the bottom of the foam insulation; and
(d) a protective cover bonded to the top of the foam insulation, said protective cover being comprised of primarily thermoplastic polyolefin or polyurea.

12. The insulation panel of claim 11, wherein the foam insulation is comprised of foam insulation plies laminated together, and wherein the closed cell foam insulation is cross-linked by irradiation.

13. The insulation panel of claim 11, wherein the closed cells of the foam insulation initially encapsulate essentially nitrogen, wherein the foam insulation is formulated with a fire retardant additive and an ultraviolet radiation resistant additive, and wherein the protective cover is formulated with a fire retardant additive and an ultraviolet radiation resistant additive.

14. The insulation panel of claim 11, wherein the insulation panel is shaped to fit a passenger compartment surface of the vehicle.

15. The insulation panel of claim 11, wherein the insulation panel is attached to a passenger compartment surface by the the adhesive after the release material is removed.

16. A kit of insulation panels as defined in claim 11, wherein each said insulation panel is shaped to fit a separate passenger compartment surface of the vehicle.

17. The insulation panel of claim 11, wherein the protective cover is primarily comprised of thermoplastic polyolefin.

18. The insulation panel of claim 11, wherein the protective cover is primarily comprised of polyurea.

19. An insulation panel for insulating the passenger compartment of a vehicle having one or more exterior passenger compartment surfaces and one or more interior passenger compartment surfaces, said insulation panel comprising:
(a) a section of insulation comprised of medium density polyethylene cross-linked closed cell foam, said section of insulation having a top surface and a bottom surface;
(b) a layer of pressure sensitive adhesive applied to the bottom of the section of insulation, said adhesive being thermally stable as an adhesive up to a temperature of approximately 250° F.;
(c) a layer of release material covering the adhesive, said release material being adapted to releasably cover the adhesive such that a nonstick surface is formed at the bottom of the foam insulation; and
(d) a protective cover bonded to the top of the foam insulation, said protective cover being comprised primarily of thermoplastic polyolefin or polyurea.

20. The insulation panel of claim 19, wherein the foam insulation is comprised of foam insulation plies laminated together, and wherein the closed cell foam insulation is cross-linked by irradiation.

21. The insulation panel of claim 19, wherein the bottom surface of the section of insulation is comprised of a layer of ethylene vinyl acetate (EVA) foam for receiving the layer of adhesive covered by the layer of release material, wherein said release material is adapted to releasably cover the adhesive such that a nonstick surface is formed at the bottom surface of the foam insulation.

22. The insulation panel of claim 19, wherein the closed cells of the foam insulation initially encapsulate essentially nitrogen, wherein the foam insulation is formulated with a fire retardant additive and an ultraviolet radiation resistant additive, and wherein the protective cover is formulated with a fire retardant additive and an ultraviolet radiation resistant additive.

23. The insulation panel of claim 19, wherein the insulation panel is shaped to fit a passenger compartment surface of the vehicle.

24. The insulation panel of claim 19, wherein the insulation panel is attached to a passenger compartment surface by the adhesive after the release material is removed.

25. A kit of insulation panels as defined in claim 19, wherein each said insulation panel is shaped to fit a separate passenger compartment surface of the vehicle.

26. The insulation panel of claim 19, wherein the protective cover is primarily comprised of thermoplastic polyolefin.

27. The insulation panel of claim 19, wherein the protective cover is primarily comprised of polyurea.
